(19) United States
(12) Patent Application Publication
(10) Pub. No.: US 2009/0085241 A1
(43) Pub. Date: Apr. 2, 2009

(54) Device for the separation of a plastic clay strand, having a notching device effective to all sides

(76) Inventors: Rainer Koch, Senden (DE); Frank Appel, Ulm (DE)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/918,766

(22) PCT Filed: May 5, 2006
(86) PCT No.: PCT/EP2006/004236

§ 371 Date: Oct. 18, 2007

(30) Foreign Application Priority Data
May 6, 2005 (DE) 10 2005 021 038.4

(51) Int. Cl. B29D 31/00

(52) U.S. Cl. 264/152

(57) ABSTRACT

The invention relates to a device for the separation of a plastic clay strand (2), movable longitudinally of a transport passage (3), into green bodies (2a), having at least one notching device (1) for notching of the clay strand (2) and a cutting device for cutting the clay strand (2) in the notches, wherein the notching device (1) has notching strips (4) arranged on all sides of the transport passage (3). In order to improve the device with regard to the notching device (1), all notching strips (4) are mounted independently of one another and they are movable at the same time out of a release position into a notching position offset towards the middle axis (3a) of the transport passage (3), and back again.

The invention relates to a device in accordance with the preamble of claims 1, 21 and 29.

A device in accordance with the preambles of claims 1 and 21 is described in DE 33 06 852 C1. In the case of this known device, the notching device includes a plurality of vertical notching strips which are arranged on a side wall, an angled wall having a horizontal wall limb and a vertical wall limb as well as several floor strips. The notching of a strand section is effected in several steps. In a first notching step a transported clay strand longitudinal section is brought to a stop, and the side wall with the vertical notching strips is moved sideways against the clay strand section and so further moved until the clay strand section is arranged in a position beside the previous transport section on the vertical wall limb and below the horizontal wall limb. By means of a lateral pressure applied with the side wall the clay strand section is notched on the two sides opposite to one another. In a second notching process the underside and upper side of the clay strand section are notched between the floor strips and the horizontal wall limb.

This known device is not only complex in terms of construction and process, because the notching is effected in two notching procedures, but it is also of a large size construction, wherein it is required for the notching to shift the clay strand section transversely of the transport passage, which is undesired or not possible in many manufacturing facilities. Beyond this there is the danger of a poor notching and cutting quality because it is difficult to place the notches in a common plane and to place them, with time delay, in the cutting plane.

The invention is based on the object of improving a device of the kind indicated in the introduction with regard to the notching device. In particular the time required for the notching is to be shortened. Also, a lateral movement of the clay strand is to be avoided and also the achievement of a favourable loading of the clay strand upon notching is striven for.

This object is achieved by the features of claim 1. Advantageous developments of the invention are described in the dependent claims.

The invention is based on the insight that in a notching of the clay strand in several notching steps following one another not only is an unfavourable load exerted on the clay strand but this also leads to a difficult construction and control of the notching components.

With the configuration according to the invention in accordance with claim 1 all notching strips are mounted independently of one another and movable from a release position into a notching position offset towards the middle axis of the transport passage, and back again. Thereby two notching strips lying opposite one another, e.g. two notching strips lying sideways opposite one another or two notching strips arranged above one another, or all notching strips, may be simultaneous movable into their notching position. With this configuration in accordance with the invention the notching strips can thus, due to their arrangement and movement independent of one another, be moved oppositely to one another and preferably at the same time for a notching procedure against the clay strand. Through this a clean surrounding notching and a clean cut can be attained. These advantages are in particular provided in that the notching is effected not at different times but at the same time at least two sides lying opposite one another. Through this tolerances hardly to be avoided with notching at different times are not only avoided in a simple manner but a simultaneous material stressing takes place at the peripheral sections of the clay strand, whereby the notches occur simultaneously in the material of the clay strand, and thereby ensures an improved formation of the notches. The time required for the notching can be shortened to the time which is required for notching with a notching strip. In addition, due to the counter-acting function of the notching strips lying opposite one another, the clay strand can remain in its transport position and therefore in the region of the transport passage. Because of the counter-acting function of the notching strips the forces causing the notching form counter-bearing forces on the opposite side, which centre the clay strand. In addition, due to the concentric arrangement of the notching strips possible according to the configuration in accordance with invention it is more easily possible to move the notching device for a notching procedure with an advancing movement adapted to the transport speed of the clay strand, to achieve notching and cutting during a continuous advance of the clay strand.

It is advantageous for the stabilization of the movement drive for the notching strips to move these by means of two push and pull devices arranged on the two sides of their longitudinal middle.

The preferably simultaneous movement of the notching strips can be carried out in particular in a simple manner if in each case two neighbouring end regions of the notching strips have mitre inclines which bound free spaces in the region of which the notching strips can move as far as their notching position and in the notching position can form a movement stop on the mitre inclines. Since it is to be expected that clay material accumulates between the mitre inclines, it is advantageous to arrange at least one recess in at least one mitre surface of the mitre inclines for receiving the clay material. If the recesses are to open to the outer periphery, e.g. overall or through channels, the clay material can be discharged away to the outside, where it does not disturb. Configuration and motion control of the notching strips in accordance with the invention are suited particularly well in combination with transversely divided notching strips, namely so-called chamfer strips, between which a cutting element, in particular a cutting wire, is transversely movable. Through this not only can the alignment of the notches or chamfers be improved, but also the alignment of the cut with regard to the chamfers and therefore the chamfer quality and cut quality can be improved.

With the device in accordance with the invention the notching strips are in a common transverse plane, whereby they are mounted independently of one another and are movable transversely of the transport passage. There is thus the requirement to so configure the device or its notching device that the notching strips stabilize themselves in their mounting at least in the notching position. This object is achieved by the features of claim 14, in which at least in one corner of the frame-like arranged notching strips, the ends of two neighbouring notching strips towards one another engage into one another in form-fitting manner and thereby in the longitudinal direction of the transport passage are supported on one another and thereby stabilized. For this form-fitting engagement the notching webs present are excellently suited, which in each case engage into a recess of corresponding cross-sectional form at least in the notching web of the neighbouring notching strip.

It is particularly advantageous to form the recess in each case in the longitudinal direction of the associated notching web in elongate manner, in particular continuously. This configuration makes it possible to adjust the notching strip having a recess transversely to the passage axis and thereby to adapt this notching strip to different cross-sectional dimensions of the strand to be notched. Depending on arrangement of the notching strips this adaptation can be effected horizontally or vertically.

It is therefore also advantageous to constitute the device or the notching device with an adjustment device which makes it possible to adjust and to place the adjustable notching strip with regard to its release position, whereby it is movable from this placed release position into the notching position and back again.

The invention also relates to forming the device or the notching device such that notching strips lying opposite one another horizontally and/or vertically are adjustable with regard to their release position and thus with regard to different cross-sectional dimensions of the strand.

A horizontal and vertical adjustability can be attained in that the notching strips in each case at one end overlap the neighbouring notching strip and at the other end are overlapped by the there neighbouring notching strip, wherein all notching strips are movable and settable by means of an adjustment device not only transversely to the passage axis but also in each case in their longitudinal direction, i.e. in the circumferential direction of the passage.

The invention is further based on the object of simplifying a device in accordance with the preamble of claim 21. In this simplification in particular both the construction and also the motion control should be involved.

This object is achieved by the features of claim 21. Advantageous development are described in associated dependent claims.

This configuration makes possible a substantial simplification of the construction and the drive. Thereby, the separating process may be effected upon the notching of the notching strips or in their notching position, through which an efficient mode of operation is attained, which also makes possible a clean cut.

An above-described combination of the processes of notching and cutting or separation can in terms of production be further rationalized and simplified in terms of construction, if a plurality of notching and cutting devices are arranged after one another in the longitudinal direction of the passage, which preferably notch and cut at the same time.

There is described in DE 80 12 592 U1 a device for the cutting of split plates from a clay strand standing on the narrow side, wherein to the two sides of the clay strand two chamfering strips are arranged oppositely in each case at a spacing from one another, which serve as guide for the cutting element movable therebetween. With this known device it requires a considerable constructive outlay and control outlay to guide and move the chamfer strips.

In addition, it is known from the EP 0 515 704 B1 to use at least one notching roller for forming the notches, which is moved along the side of the clay strand be notched and thereby forms the notch. By means of a cutting wire which is arranged and effective with regard to the notching roller offset in location and from the point of view of time, the clay strand is cut in the notch after the notching. This configuration also is complex in terms of construction and control technology.

The invention therefore is based further on the object of improving the cutting of a device in accordance with the preamble of claim 29 whilst ensuring a compact construction.

This object is achieved by the features of independent claim 29. Advantageous developments of the invention are described in associated dependent claims.

With the device in accordance the invention in accordance with claim 29 the notching roller is formed by two roller plates which have an axial spacing from one another, wherein the cutting wire extends between the roller plates and intersects the middle region of the roller plates. With this device the cutting takes place continuously during the notching. Through this not only is the time for processing reduced but the device is also of a compact construction, because the cutting wire is effective in the arc region in which the associated roller plates enter into the clay strand and form the notch. Since the cutting wire is always in the middle region of the roller plates, it is not only always centred in the notch but also its guiding is ensured continuously. In addition, the notch is continuously formed and stabilized during the cutting by the roller arc sections always present in front of and behind the cutting wire. There is therefore attained not only a clean notch but a clean cut, wherein the notching periphery sections and the cut align with one another in the common transverse plane.

The configuration in accordance with the invention can be combined with conventional notching devices and chamfering devices arranged on neighbouring sides of the transport passage, in order also on these sides to obtain a clean cut.

In addition, the configuration in accordance with the invention makes it possible to constitute notching roller holders arranged on two sides of the transport passage as holders for the cutting wire so that they form the cutting device with the cutting wire.

Below, advantageous configurations of the invention will be explained in more detail with reference to several embodiments and the drawings. There is shown:

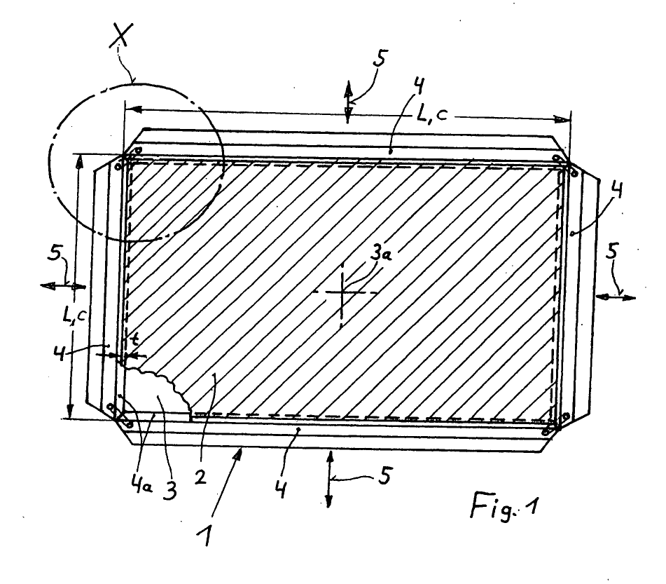

FIG. 1 a simplified representation of a notching device in accordance with the invention for a device in accordance with the invention for the separation of a plastic clay strand, in a front view, wherein the notching device is in its notching position;

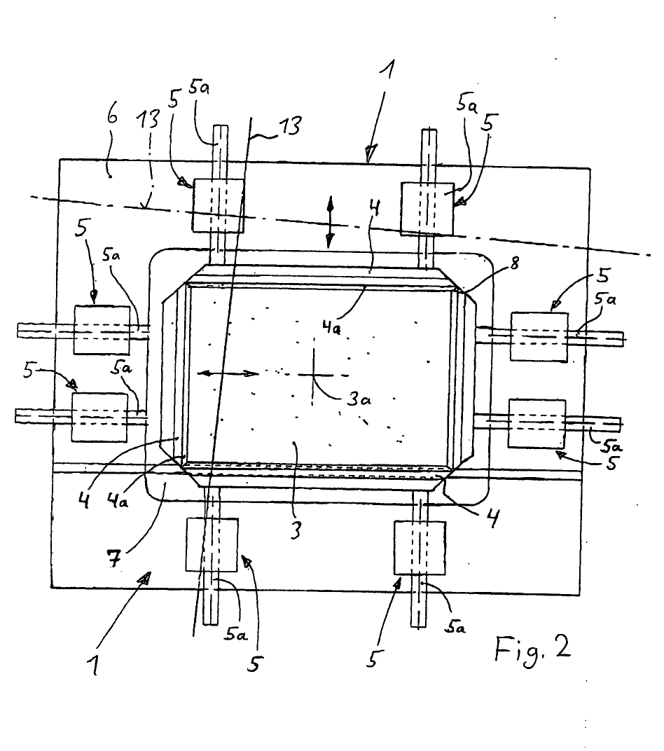

FIG. 2 a notching device in accordance with FIG. 1, in modified configuration;

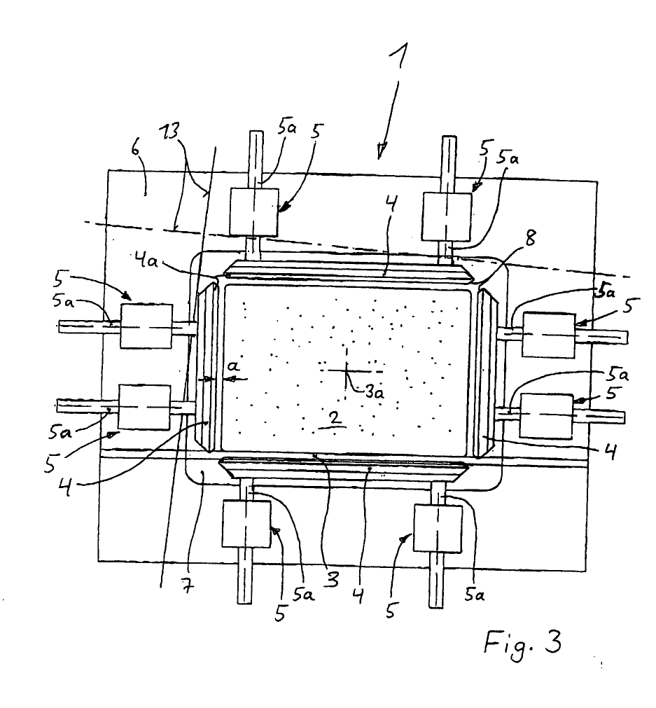

FIG. 3 the notching device in accordance with FIG. 2, in its release position;

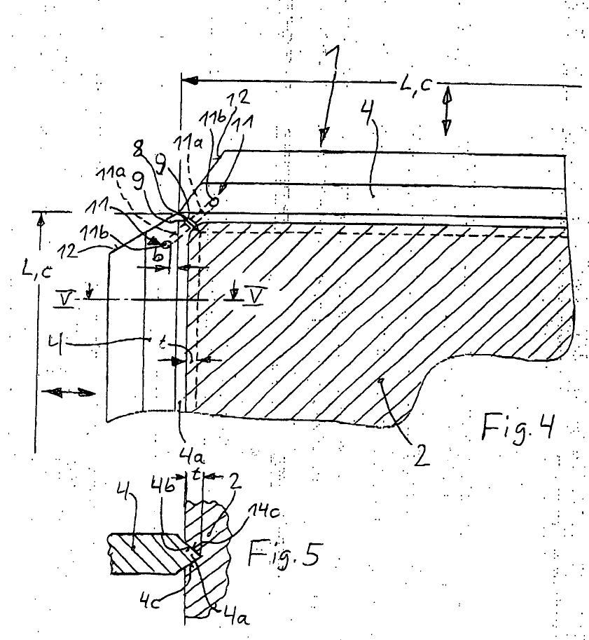

FIG. 4 the detail marked with X in FIG. 1, in a representation to an enlarged scale;

FIG. 5 the part section V-V in FIG. 4;

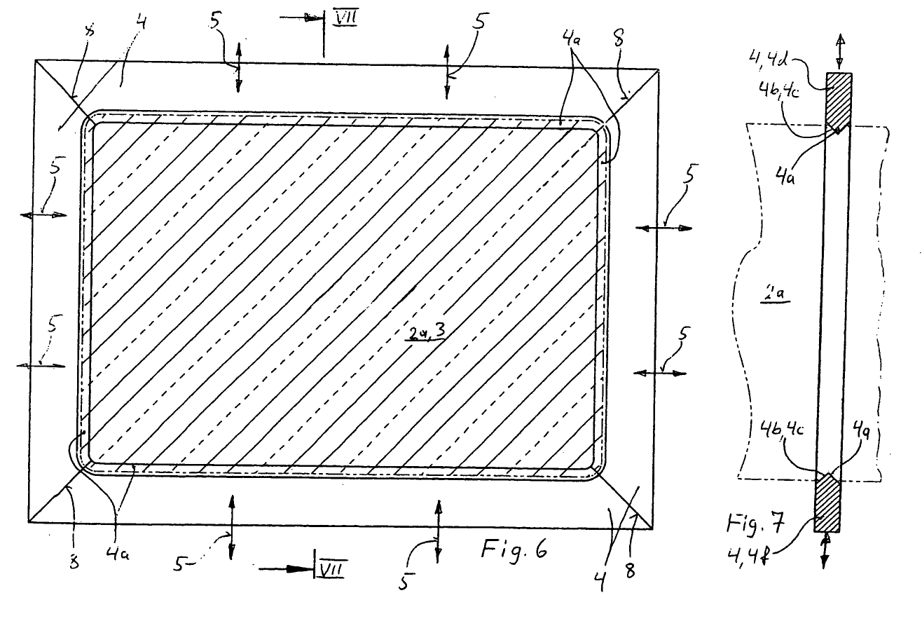

FIG. 6 a simplified representation of a notching device in accordance with the invention in a further modified configuration, for a device in accordance with the invention for the separation of a plastic clay strand, in a front view, in which the notching device is in its notching position;

FIG. 7 the section VII-VII in FIG. 6;

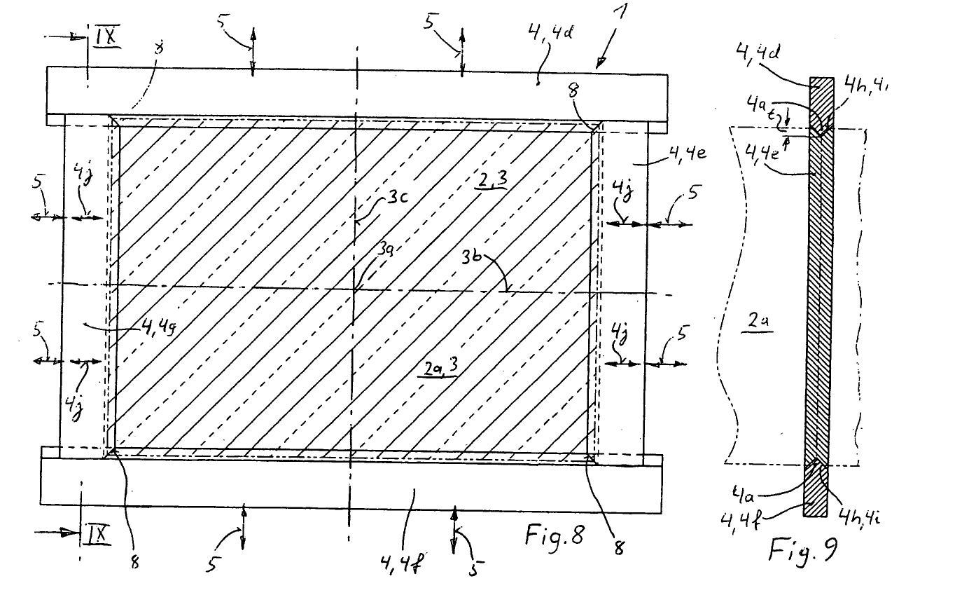

FIG. 8 a simplified representation of a notching device in accordance with the invention in a further modified configuration, for a device in accordance with the invention for the separation of a plastic clay strand, in a front view, in which the notching device is in its notching position;

FIG. 9 the vertical section IX-IX in FIG. 8;

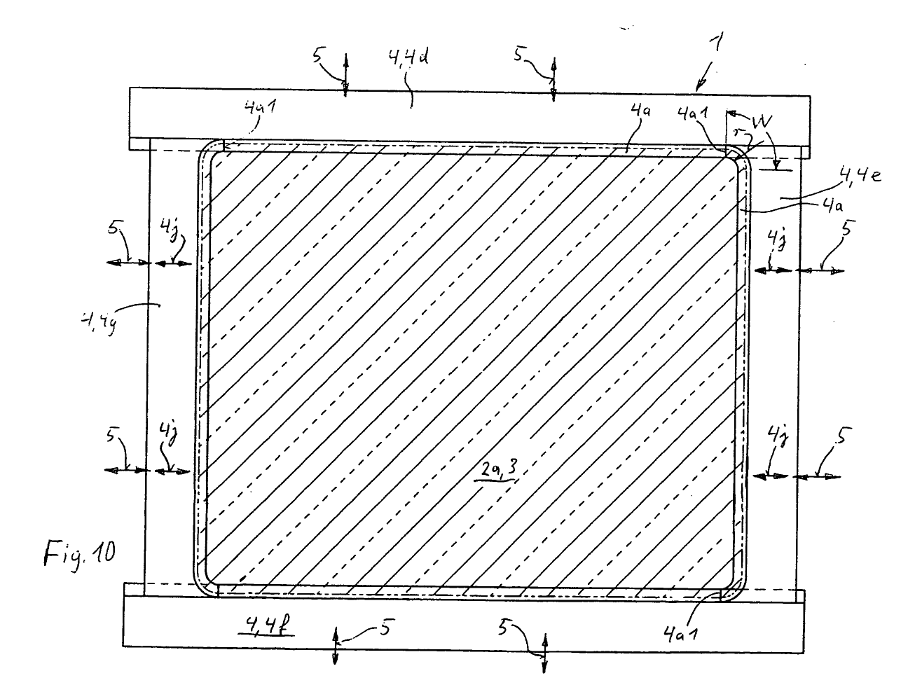

FIG. 10 a simplified representation of a notching device in accordance with the invention in a further modified configuration, for a device in accordance with the invention for the separation of a plastic clay strand, in a front view, in which the notching device is in its notching position;

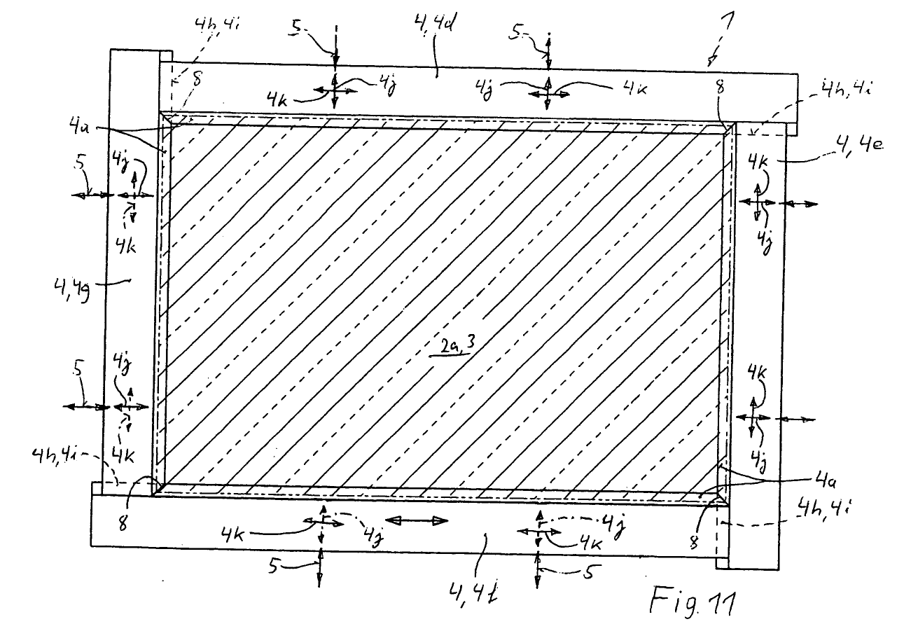

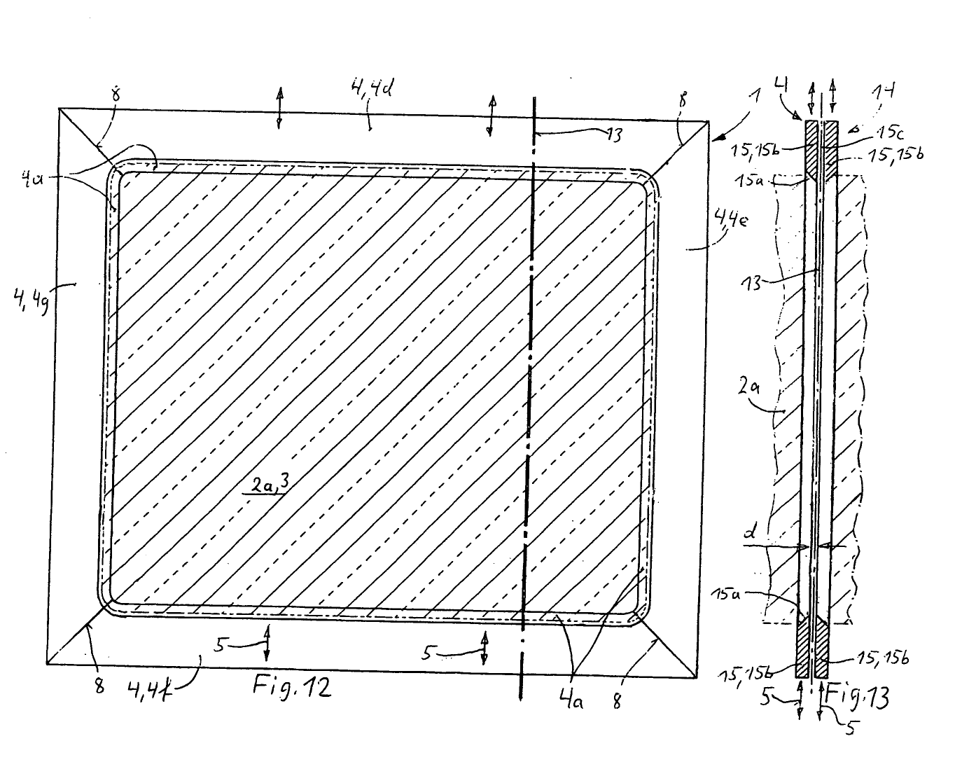

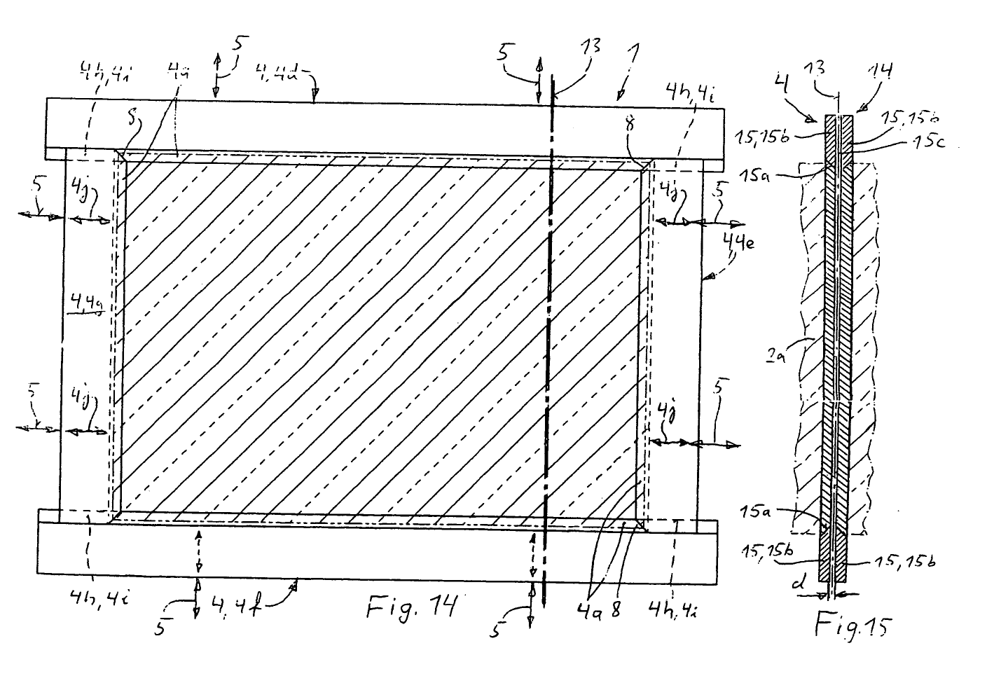

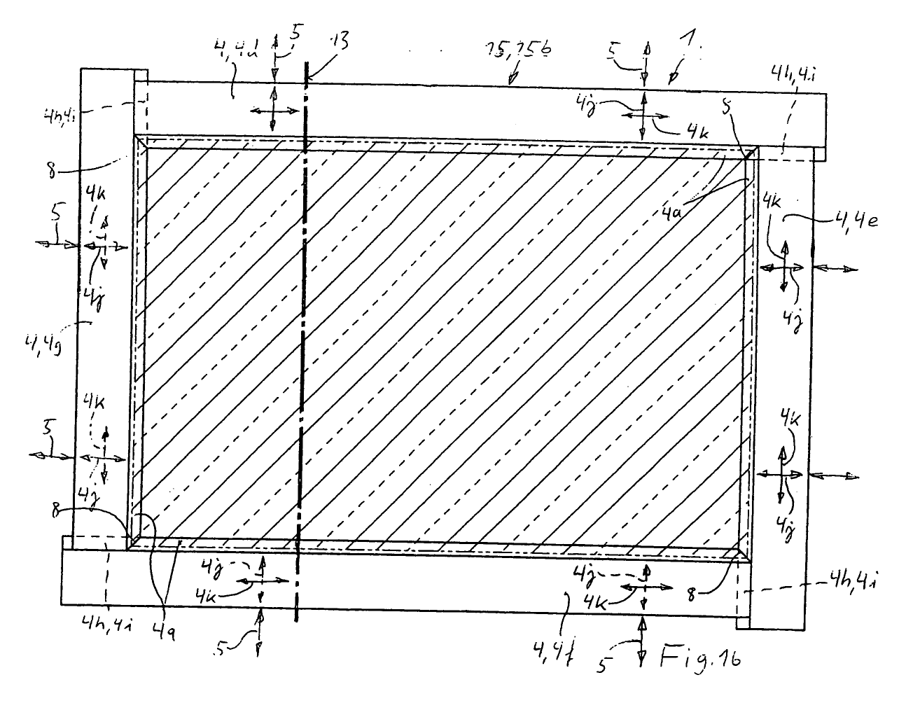

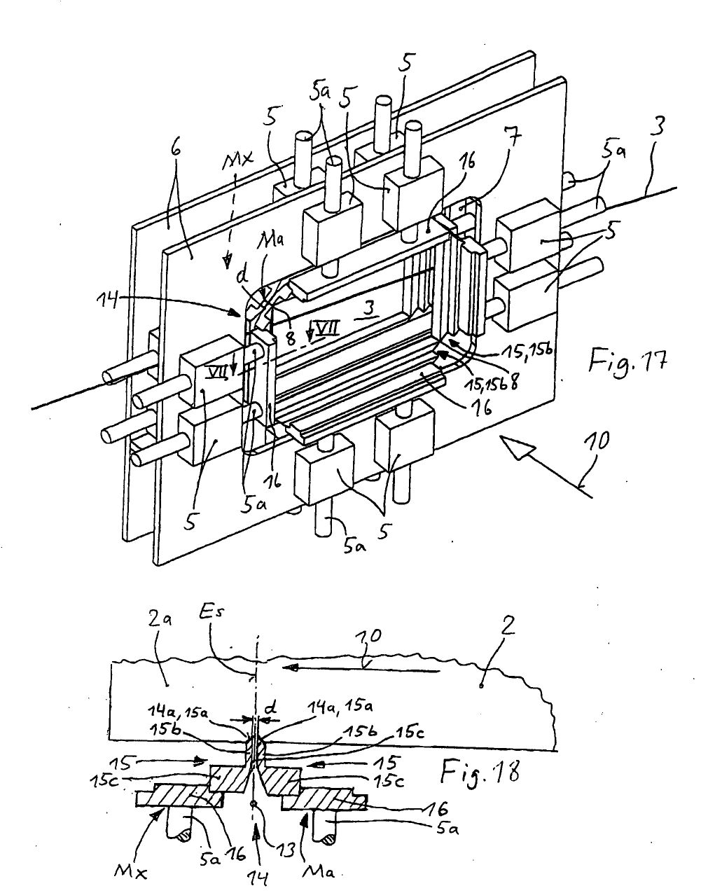

FIG. 11 a simplified representation of a notching device in accordance with the invention in a further modified configuration, for a device in accordance with the invention for the separation of a plastic clay strand, in a front view, in which the notching device is in its notching position;

FIG. 12 a simplified representation of a notching device in accordance with the invention in a further modified configuration, for a device in accordance with the invention for the separation of a plastic clay strand, in a front view, in which the notching device is in its notching position;

FIG. 13 the vertical section XIII-XIII in FIG. 12;

FIG. 14 a simplified representation of a notching device in accordance with the invention in a further modified configuration, for a device in accordance with the invention for the separation of a plastic clay strand, in a front view, in which the notching device is in its notching position;

FIG. 15 the vertical section XV-XV in FIG. 14;

FIG. 16 a simplified representation of a notching device in accordance with the invention in a further modified configuration, for a device in accordance with the invention for the separation of a plastic clay strand, in a front view, in which the notching device is in its notching position;

FIG. 17 a simplex notching and cutting device in accordance with the invention having an initial module and an end module, in a further modified configuration and in a perspective view;

FIG. 18 the horizontal part section XIII-XIII in FIG. 17;

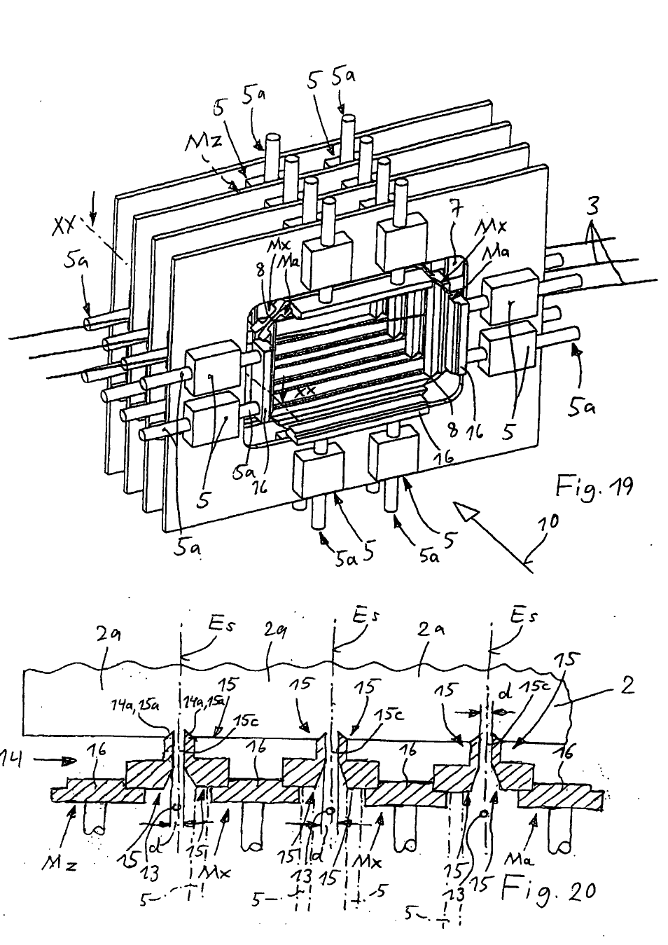

FIG. 19 a multiplex notching and cutting device in accordance with the invention having an initial module, a plurality of extension modules arranged one behind another other longitudinally of a transport passage of the clay strand and an end module, in a perspective view;

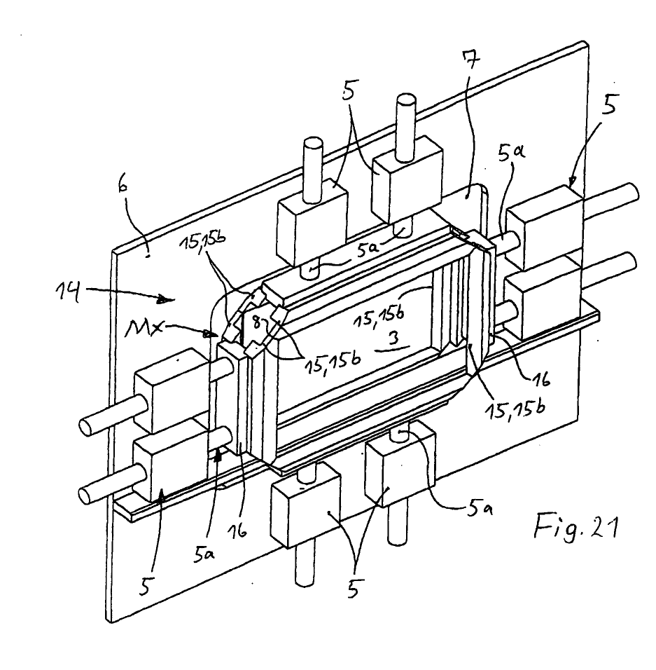

FIG. 20 the horizontal part section XX-XX in FIG. 19;

FIG. 21 an extension module of the notching device, in a perspective view;

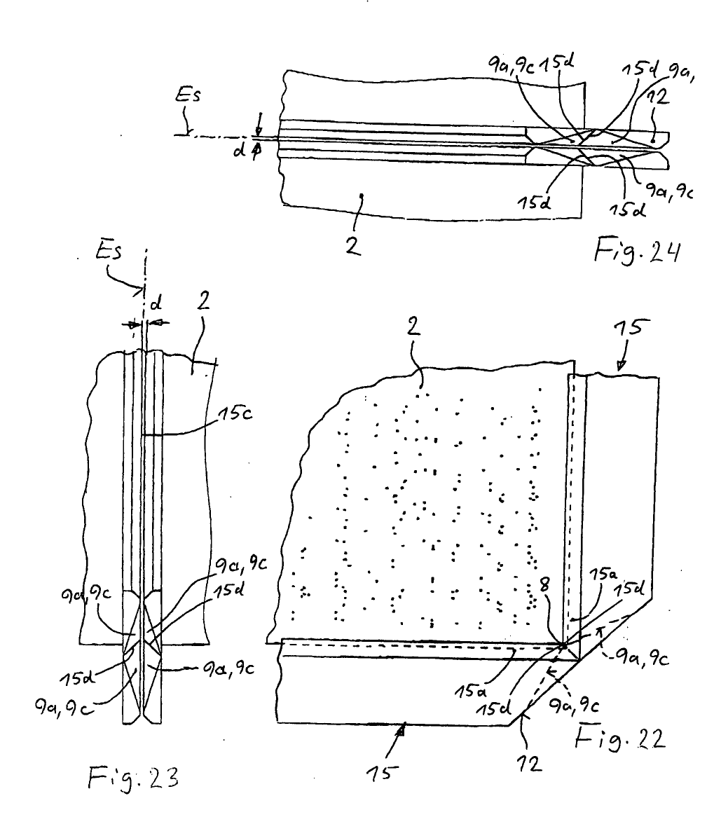

FIG. 22 the lower corner region of two chamfer strips which form a divided notching strip, in a direction of view longitudinal of the transport passage, in a representation to an enlarged scale;

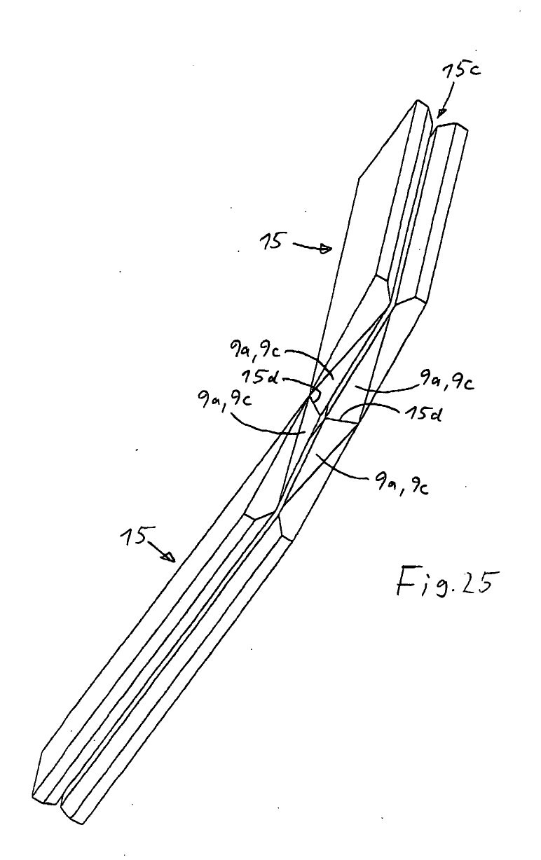

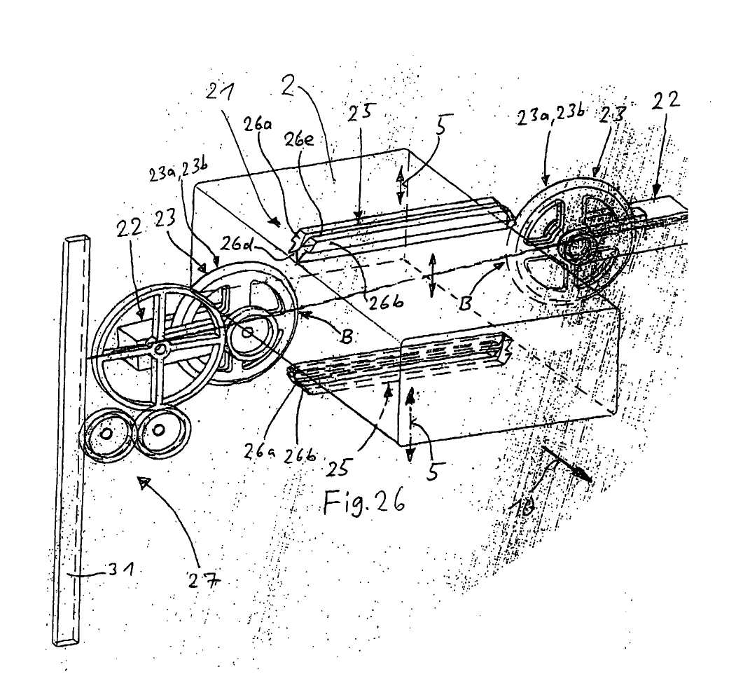

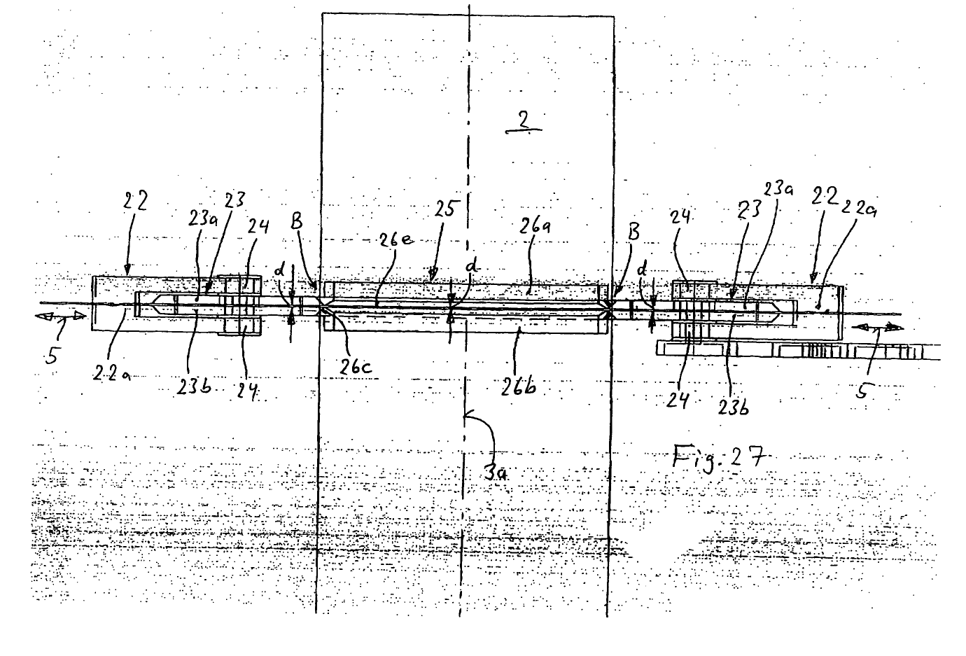

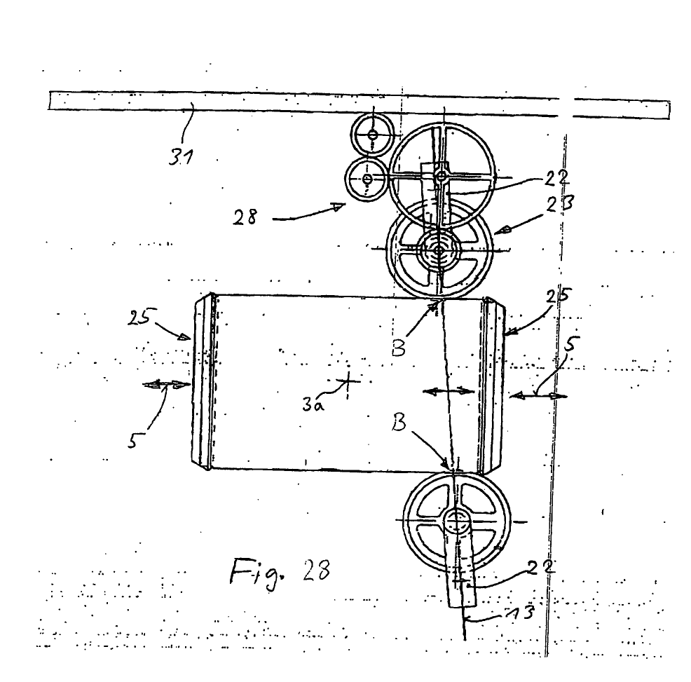

FIG. 23 the corner region in a side view from the left;

FIG. 24 the corner region in a view from below;

FIG. 25 the corner region in a perspective view from below;

FIG. 26 a notching device in accordance with the invention in a further modified configuration with approximately vertical cutting direction, in a perspective view;

FIG. 27 the notching device in accordance with FIG. 26 in a view from above;

FIG. 28 the notching device in an arrangement with a horizontal cutting direction.

The notching device, designated by 1 as a whole, is a component unit of a device, not further represented in FIGS. 1 to 5, for the separation of a plastic clay strand 2 into green bodies, wherein the clay strand 2 and the green bodies are transported on a transporter, likewise not represented detail, through a transport passage 3. The transport passage 3 may extend from an extruder for extruding the clay strand 2.

For all embodiments the same or similar parts are designated by the same reference signs.

The notching device 1 has 4 notching strips 4 which on all four sides of the transport passage 3 extend transversely over the complete respective side of the transport passage 3 in a common transverse plane which stands at right angles to the middle axis 3a of the transport passage 3. The notching strips 4 are respectively adjustable transversely of the transport passage 3 by means of a push and pull drive 5 indicated in FIG. 1 as a double arrow. The push and pull drive 5 may respectively be formed e.g. by means of a spindle drive or by a hydraulic cylinder having a piston rod which can be moved in and out. Thereby the notching strips 4 are respectively movable from a release position, in which a notching web 4a located on their inner edge has a distance from the clay strand 2 or from a relevant cross-sectional dimension of the transport passage, in direction towards the transport passage 3 into a notching position in which the notching web 4a is pressed in into the clay strand 2 to a predetermined notching depth t. The notching webs 4a have respectively the desired notching contour or the desired notching angle.

Since the notching strips 4 are similarly constituted and correspondingly arranged with regard to the transport passage 3 and are movable by the associated push and pull drive 5, for simplification a description of the other notching strips 4 in detail can be omitted.

The same or similar parts are provided with the same reference signs in the other embodiments still to be described.

The embodiment according to FIG. 2 differs from the embodiment according to FIG. 1 in that here two push and pull drives 5 are associated with each notching strip 4, which drives with respect to the associated notching strip 4 have a spacing from one another in the circumferential direction and engage off-centre and preferably symmetrically on the associated notching strip 4. The push and pull rods engaging on the notching strips 4 are in each case designated by 5a. The push and pull drives 5 are attached to a frame 6 which surrounds the transport passage 3 in ring-like manner and has an appropriately large middle free space 7 for the transport passage 3. The frame 6 is a part of the otherwise not illustrated device and held on this.

FIG. 3 shows the embodiment in accordance with FIG. 2 in the withdrawn release position of the notching strips 4, in which the notching webs 4a are in each case arranged at an outwardly directed spacing a from the clay strand 2 or from a corresponding transverse dimension of the transport passage 3.

The notching strips 4 have, in the region of their end regions in each case forming a corner with the neighbouring notching strip 4, mitre inclines 8, which make it possible to move the notching strips 4 so far in direction towards the transport passage 3 that they press into the clay strand 2 with their notching webs 4a or project into the transport passage 3. The mitre inclines 8 are preferably so arranged that in the notching position in accordance with FIGS. 1, 2 and 4 the mitre inclines 8 of the notching strips 4 neighbouring one another bear on one another. Through this there is also provided a movement stop for the notching movement of the notching strips 4.

Since upon notching of the clay strand 2 clay material is displaced in the region of the notch 4b, it is to be expected that upon the notching movement of the notching strips 4 clay material arrives between the mitre inclines 8. To prevent or at least to reduce an exit of the clay material to the side of the mitre inclines 8, it is advantageous to arrange in at least one, preferably in both, facing mitre surfaces of the mitre inclines 8, at least one recess 9 which receives the clay material. It is further advantageous to arrange in the notching strip or notching strips 4 discharge channels 11 for the clay material which extend in each case from the recess 9 and open out of the notching strip 4 at a spacing b from the associated notching web 4a. By means of the discharge channels 11, in each case the clay material enclosed between the mitre inclines 8 is led to a channel exit, in the region of which the clay material, due to its distance b from the clay strand 2, does not affect this strand, e.g. by material contact. In the case of the embodiments in accordance with FIGS. 1 to 4 the discharge channels 11 are formed by means of channels 11a extending transversely of the mitre inclines 8, which open into channels 11b extending transversely of the sides faces of the notching strips 4, the exit openings of which are therefore arranged in the side faces of the notching strips 4. If the recesses 9 are open towards the outer perimeter, the material can be cleanly discharged towards the outer periphery.

The notching surfaces 4c of the notching webs 4a penetrating into the material may correspond to a desired contour and are preferably formed wedge shaped, e.g. with a wedge angle of approximately 90°.

The notching strips 4 may in each case have a length L which corresponds to the outer spacing c of the notching webs 4a from notching strips 4 lying opposite to one another. With such a length L the notching strips 4 neighbouring to one another cover themselves in each case only in the region of the notching webs 4a. Thereby the end faces of the notching strips 4 may by tapered by oblique surfaces 12, as shown by FIGS. 1 to 4 and 17 to 26.

For a notching process all notching strips 4, here four of them, are moved at the same time from their release position in accordance with FIG. 3 into the notching position in accordance with FIGS. 1, 2 and 4. Thereby in each case the notching pressure of notching strips 4 lying opposite one another acts as counter-pressure. Consequently the clay strand 2 is subject to pressure not on one side only but from the two sides lying opposite one another, through which the clay strand is stabilized in form, which is favourable for a desired maintenance of the position of the clay strand with regard to the middle axis 3a of the transport passage 3. The danger that the clay strand 3 moves to the side upon notching is therefore avoided or is slight or reduced.

The device has at least one cutting device with a cutting wire 13 extending at right angles to the transport passage 3 for the horizontal or vertical cutting of the clay strand 2. Such a cutting device is known per se and therefore does not need to be described in detail. In the embodiment according to FIGS. 1 to 5 it is arranged offset with regard to the notching device 1 in the longitudinal direction of the transport passage 3, and it is effective by means of a horizontal or vertical movement of the cutting wire 13 through the clay strand 2 in the region of the notches 4b present on all sides. The cutting is effected, with the notching devices in accordance with FIG. 1 to 5, thus offset in terms of location and from the point of view of time from the notching with the notching device 1.

The embodiment of the notching device 1 according to FIGS. 6 and 7 corresponds in principle to the above-described embodiments, whereby however there is involved a notching device 1 for the notching of a strand 2 with rounded longitudinal edges. With such a configuration the notching webs 4a are rounded concavely in the region of the corners present, wherein the notching webs 4a at their ends rise rounded in the region of a ⅛ circle and run out at the mitre incline 8. With this embodiment and also with the embodiments up to FIG. 15 the notching strips 4 or 4d to 4g are formed by flat strips the thickness of which may correspond to the width of the associated notching web 4a. Beyond this, with the embodiment in accordance with FIG. 6 there are omitted the outer corners supported e.g. by oblique surfaces 12, whereby the mitre inclines 8 extend e.g. up to the outer corners of the notching strips 4.

With the embodiment in accordance with FIGS. 8 and 9 the notching device 1 is formed differently in the region of the ends of two notching strips towards one another, wherein this modified configuration may be arranged only in one or in two oppositely lying or in all corner regions of the notching device 1. It is the purpose of this modified configuration to stabilize the mounting of the notching strips and this at least in a corner region of the passage 3. The stabilization is attained in that the one notching strip 4d with at least its notching web 4a is extended over at least the notching web 4a of the other notching strip 4e, and the other notching strip 4e has at least in its end wall region overlapped by the notching strip 4d a recess 4h for the notching web 4a of the one notching strip 4d. Preferably the cross-sectional form of the recess 4h is so adapted to the cross-sectional form of the notching web 4a which enters therein that the notching web 4a with its e.g. wedge shaped flanks 4c bears in form-fitting manner on the flanks 4i of the recess 4h and fills the recess 4h. Through this the two notching strips 4d, 4e are supported and stabilized on one another in form-fitting manner at least in the longitudinal direction of the passage 3.

Thereby, both notching strips 4d, 4e are movable between their release position and their notching position, in order to execute a notching process. For the overlapped notching strip 4e this is ensured also in the notching position of the one notching strip 4d when the degree of overlapping, with which the notching web 4a of the one notching strip 4d overlaps the notching web 4a of the other notching strip 4e, is greater than the stroke between the release position and the notching position. In the case of the embodiment the one notching strip 4d is extended to a greater degree over the other notching strip 4e, preferably at least up to the outer edge of the other notching strip 4e, whereby the recess 4h in the other notching strip 4e extends over the complete width thereof, i.e. continuously. Through this the shaping is simplified because both the one notching strip 4d and also the recess 4h can be constituted in profile form or continuously. Beyond this, with this configuration it is possible to move the overlapped notching strip 4e in the longitudinal direction of the overlapping notching strip 4d transversely of the passage 3, in order to be able, on at least one side of the strand, to adjust to different strand dimensions.

In the region of the other corners of the notching device 1 this can be differently formed, e.g. with mitre inclines 8 of the above-described embodiments.

It is, however, advantageous for the following reasons to form the notching strip 4f lying opposite the one notching strip 4d and the other notching strip 4e formed in an above-described manner mirror symmetrically with regard to a longitudinal middle plane 3b extending—here horizontally—transverse to the other notching strip 4e or with regard to the vertical longitudinal middle plane 3c of the passage 3 bounded by the notching strips 4d, 4e, 4f, 4g. Through this it is possible to move the notching strips 4e, 4g between the notching strips 4d, 4f in direction towards the passage 3 and back again, and thus to change and set to a desired amount the relevant cross-sectional dimension of the passage 3 and its horizontal width. There is therefore required for the notching of differently broad strands 2 no particular notching strips 4e. For the adjustment of a desired width, this notching device 1 is so configured that it is adjustable with regard to its release position taking into account the desired width of the passage 3 or strand 2. The amount of cross-sectional offset may be small or great, e.g. smaller or greater than the height or width of the notching strips 4d to 4g.

With an arrangement of the notching device 1 in accordance with FIG. 8, rotated in the transverse plane by 90°, different strand heights can be set.

The setting of the respective strand dimension can be effected by a suitable adjustment device 4j for positioning and placing the notching strip 4e, 4g concerned. The adjustment device 4j is indicated by a double arrow extending transversely to the associated notching strip 4e, 4g. For each notching strip there may be centrally provided a single adjustment device 4j (not illustrated) or there may be provided two adjustment devices 4j arranged off-center with regard to the longitudinal direction of the notching strip, as the embodiments according to FIGS. 8 to 16 show. By means of the at least one adjustment device 4j the notching strip in question can be adjusted and set with regard to its release position to the inside or to the outside. From the release position the notching strip can be moved into the notching position and retracted again by means of the associated push and pull drive 5.

FIG. 8 shows the notching strips 4d to 4g in the notching position in which the notching webs 4a are pressed into the strand 2 by the notching depth t and bear on one another with their mitre inclines 8, whereby the overlapping notching webs 4a of the upper and lower notching strip 4d, 4f are located in the recesses 4h of the lateral notching strips 4e, 4g. From these notching positions the notching strips 4d to 4g are moved by the push and pull drives 5 respectively by a movement directed transversely outwardly into the release positions not illustrated in the case of this embodiment but which are comparable with the release positions represented in FIG. 3.

Within the scope of the invention the movements of all notching strips 4d, 4g into the notching positions can be effected at the same time, whereby in each case on all sides a two-sided notching pressure is exerted on the strand 2, which cancels out. However, it is also possible firstly to move the upper and the lower notching strip 4d, 4f into the notching position and then to move the lateral notching strips 4e, 4g into the notching position, whereby the notching webs 4a of the horizontal notching strips 4d, 4f, with the recesses 4h of the lateral notching strips 4e, 4g, in each case form a guide F, in which the notching strip ends engaging into one another are held on one another in form-fitting manner in the longitudinal direction of the passage 3. If, in contrast, the notching strips 4d to 4g are moved at the same time into the notching position, they find the aforementioned form-fitting support and stabilization on one another only in the notching movement end position.

In the embodiment according to FIGS. 8 and 9 the upper and the lower notching strip 4d, 4f have no adjustment device 4j, so that this notching device 1 is adaptable in each case only to different width dimensions of the strand 2. In principle, it suffices for a lateral adjustability of the notching device 1 to a desired strand width if only one of the two lateral notching strips 4e, 4g is adjustable by means of an adjustment device 4j. If, in contrast, both lateral notching strips 4e, 4g are adjustable, a symmetrical setting with regard to the longitudinal axis 3a of the transport passage 3 can be realised, which is desired because the strand 2 is preferably centrally transported through.

The embodiment according to FIG. 10 is different from the embodiment according to FIG. 8 in that the notching webs 4a of the overlapped notching strips 4e, 4g extend rounded concavely in their end regions, to bound rounded corners or round corners and to notch a strand 2 with rounded longitudinal edges. In the embodiment the notching webs 4a are curved in the region of an angle W of approximately 90°, whereby they run out at end edges 4a1 at the flanks 4c of the continuously formed notching web 4a of the overlapping notching strip 4d, 4f. The inside radius r of the concave curvature is e.g. as large as the notching depth t.

For the realization of the adjustment device 4j there are a plurality of functional configurations. It is significant that the notching strip 4e, 4g in question is movable relatively to a carrier carrying it, e.g. the frame 6, into the respectively desired release position and is thus adjustable. This can e.g. be realized in that the at least one respectively associated push and pull drive 5 is movable relative to the carrier or frame 6 in direction towards the transport passage 3, and back, and is fixable in the respective adjustment position, or the respectively associated at least one push and pull rod 5a is movable relative to its guide housing in direction towards the transport passage 3, and back, and is positionable in the respective adjusted position or the respective notching strip 4 is adjustable relative to the associated at least one push and pull rod 5a and positionable in the respective adjusted position.

In the case of the embodiment of FIG. 11 the notching device 1 is adjustable both with regard to different strand widths and strand heights.

With regard to an adjustability of the strand height it is in principle to be noted that it requires merely an adjustability of the release position of only the upper notching strip 4d, because the underside of the strand 2 is always, even in the presence of different strand heights, always of the same height, which is determined in this regard by a non-adjustable transport support for the strand 2.

With the embodiment in accordance with FIG. 11 the corner regions of the frame-like notching strip arrangement lying opposite one another horizontally or vertically are not, with regard to the vertical longitudinal middle plane 3c or the horizontal longitudinal middle plane 3b of the transport passage 3, formed in mirror image manner as in the case of the embodiment of FIG. 8, but formed and arranged rotated equally and by 90°. Therefore all notching strips are constituted so that with their one end region they overlap partly or completely the neighbouring end of the other notching strip and have at their other end the recess 4h, whereby at least in this recess region they are overlapped by the notching strip associated with this notching strip end with a notching web 4a engaging into the recess 4h. That is, the corner regions formed by end regions of the notching strips neighbouring one another are constituted in principle the same, however the corner region following in each case in the circumferential direction is arranged and formed with regard to the previous corner region rotated by 90°. This is achieved in that the notching strips have in each case at one end the preferably continuous recess 4h, into which the notching web 4a of the neighbouring overlapping notching strip engages, and at their other end engage with the associated notching web 4a into the preferably continuous recess 4h of the notching strip neighbouring this end.

Beyond this all notching strips 4d to 4g are adjustably mounted in their longitudinal direction and this in the same circumferential direction and by means of a second adjustment device 4k are adjustable and positionable in the respective adjusted position. These adjustment devices 4k make it possible to adjust the respectively associated notching strip 4d to 4g in the circumferential direction and to adapt their overlapped ends to the desired transverse dimension of the strand 2, i.e. to the desired width and/or height. For this adjustability different relative motions can be made use of, which have already been described for the adjustment device 4j. Also the adjustment devices 4k can be constituted in each case in the sense of these alternative configurations for the adjustment device 4j.

For an adjustment and setting of the strand width the lower notching strip 4f and the laterally overlapping notching strip 4e are displaced horizontally, namely to the left or to the right, so far that the lateral notching strip 4e overlapping them is in the desired release position. In a corresponding manner also the upper notching strip 4d and the oppositely lying lateral notching strip 4g are horizontally adjusted and set by positioning, which is made possible for the upper notching strip 4d by the adjustment device 4k and for the lateral notching strip 4g is made possible by at least one adjustment device 4j.

For a reduction or increase of the strand height the here right-side notching strip 4e and the upper notching strip 4d are adjusted upwardly or downwardly and positioned, which is made possible for the lateral notching strip 4e by the at least one adjustment device 4k, and for the upper notching strip 4g by the at least one adjustment device 4j, so that also the upper notching strip 4d is in the desired release position.

For a horizontal and vertical reduction or increase of the notching strip arrangement all notching strips 4d to 4g are adjusted and positioned in above-described manner and thus set.

Since, because of a constant height of the underside of the strand, a vertical adjustment of the lower notching strip 4f is not required and therefore the release position thereof usually is not changed, there is also not needed any vertical adaptation of the lateral notching strip 4g overlapped by the lower notching strip 4f. That is, no first adjustment device of 4j is needed for the lower notching strip 4f and no second notching device 4k is needed for the underlapped lateral notching strip 4g. However, for reason of similar construction these adjustment devices may be present, which is indicated by a broken-line illustration.

The embodiments according to FIGS. 12 to 17 are different from the above-described embodiments in that a notching and cutting device for notching and cutting the clay strand 2 is provided in a common transverse plane. This notching device is formed by a chamfering device 14, which presses chamfers 14a, 14b into the clay strand 2 at the edges of the face ends of green bodies 2a still to be cut, wherein in each case two chamfers 14a, 14b neighbouring one another at the cutting plane of the clay strand 2 in common form a notch. With this configuration there are arranged on all sides of the transport passage 3 two transversely divided notching strips, namely so-called chamfering strips 15, parallel to one another, which—seen in the longitudinal direction of the transport passage 3—correspond to the configuration of the undivided notching strips 4, so that for the description of the chamfering strips 15 reference is made to the description of the notching strips 4 including the mitre surfaces 8 and the push and pull drives 5.

So far as the joints present in the corner region between the notching strips are concerned, the embodiment of FIGS. 12 and 13 corresponds to the embodiment in accordance with FIGS. 6 and 7, the embodiment in accordance with FIGS. 14 and 15 corresponds to the embodiment in accordance with FIGS. 8 and 9, the embodiment of FIG. 16 corresponds to the embodiment in accordance with FIG. 10, and the embodiment in accordance with FIG. 18 corresponds to the embodiment in accordance with FIGS. 2 to 5, whereby in the latter case however the notching strips 4 or 4d to 4g are formed by the chamfering strips 15 and form a particular notching device, namely a chamfering device 14. In accordance with the embodiments according to FIGS. 12 to 16, in contrast to the embodiment in accordance with FIG. 18, the chamfering strips 15 are formed, however, by flat chamfering strips 15, the thickness of which substantially corresponds to the thickness of the chamfer webs 15b of the embodiment in accordance with FIG. 18, while the chamfering strips 15 of the embodiment in accordance with FIG. 18 are constituted in cross-section in angled manner.

Seen in cross-section in accordance with FIGS. 13, 15 and 18 the chamfering strips 15 have a spacing d from one another, extending longitudinally of the transport passage 3, and therefore have a slit 15e between them which in the region of their edges towards the transport passage 3 corresponds to the cross-sectional size of the cutting wire 13 of the cutting device, taking into consideration a play for movement.

The chamfer surfaces 15a on the chamfering strips 15, corresponding to the desired cross-sectional form of the chamfers 14a, 14b are preferably also wedge surfaces which include an acute angle of in particular approximately 45° with the transversely running cutting plane. The thus e.g. oblique chamfer surfaces 15a are arranged on chamfer webs 15b extending transversely towards the transport passage 3, on which the push and pull drive 5 indirectly or directly engages. In the embodiment the chamfer strips 15 with their chamfer webs 15b and strip webs 16 are formed in angled manner, whereby the push and pull drives 5 engage on the strip webs 16. The two chamfer strips 15 are arranged with regard to the cutting plane Es in mirror image manner. Between the chamfer web 15b and the strip web 16 there may be arranged an angled chamfer web foot 15c. Outwardly the slit present between the chamfer webs 15b is formed divergently funnel shaped, in particular in the region of the thickened chamfer web foot 15c, to make easier the introduction of the cutting wire 13. This configuration of the recesses 9a in the view in accordance with FIG. 24 is the same as the above-described configuration.

The chamfer webs 15b are firmly connected to the associated strip web 16 and this form in each case a movement unit, which in the sense of the above-described embodiments in each case is movable by means of one or two push and pull drives 5 between the chamfering position illustrated in FIG. 18 and the retracted (not illustrated) release position.

Also the chamfering strips 15 have at least one recess in the region of their mitre inclines 8, which is open to the outside and can carry the clay material away. In this embodiment the recesses are also in each case “divided” by the distance d between the chamfering strips 15, designated by 9a and not only open to the outside but also to the slit 15c.

As FIGS. 22 to 25 show, the recesses 9a are with regard to the cutting plane Es (FIG. 23) and the mitre inclines 8 (FIG. 22) formed in mirror image manner and formed by recess surfaces 9c divergent to the outside and with regard to the cutting plane Es. These recess surfaces 9c are preferably so formed that they run out at the edges 15d formed by the mitre incline 8. The recess surfaces 9c can also run out in a small outwardly directed spacing from the edges 15d (not illustrated).

With this configuration upon chamfering the clay material located between the mitre inclines 8 is pinched off by the edges 15d and separated to the outside, through which in the corner regions of the clay strand 2 clean chamferings are attained.

The configuration of the recesses 9a in the view in accordance with FIG. 24 is the same as the above-described configuration.

Since all chamfering strips 15 are formed the same, also with regard to the mitre inclines 8 and recesses 9, and are comparably to the notching strips 4 arranged and driven at the perimeter of the transport passage 3, for reasons of simplification there is needed only the following functional description.

As already the notching device 1 of the embodiment according to FIGS. 1 to 5, the chamfering devices 14 and the cutting device indicated by the cutting wire 13 are also advanced for a notching and cutting process in a manner known per se with the advancing speed of the clay strand 2.

For a chamfering process the chamfering strips 15 are pressed, preferably at the same time, against the clay strand 2, whereby they press with their chamfering webs 15b into the clay strand 2 two mirror image arranged chamfers 14a.

The cutting of the clay strand 2 by a cutting device known per se, of which only the cutting wire 13 is illustrated, can be effected during the chamfering movement and/or when the chamfering strips 15 are in their chamfering position and/or when the chamfering strips 15 are moved back into in their release position. Thereby the cutting device with the cutting wire 13 is located in the cutting plane Es.

The movements of the chamfering strips 15 and the cutting wire of the cutting device correspondingly repeat for the chamfering and cutting of the next green body 2a. The embodiment according to FIGS. 17 and 18 thus includes a simplex notching and cutting device.

The above-described advantages are also achieved if at first only two, in particular lying opposite one another, notching strips 4 or chamfering strips 15 are advanced and then the other two are advanced preferably likewise at the same time. Particularly advantageous is the simultaneous advance movement of all notching or chamfering strips 4 or 15. The above-described also applies to the return movement of the notching strips 4 or chamfering strips 15.

In the embodiment according to FIGS. 17 and 18 the chamfering strips 15 form an initial module Ma and a end module Mz. For a simultaneous cutting off of a plurality of green bodies 2a there are arranged one after another a plurality of such modules and cutting devices in the desired number in the longitudinal direction of the transport passage 3 at spacings corresponding to in the green body length, whereby the chamfering and cutting in the sense of the above-described possibilities can be effected at the same time at all chamfering devices 14 and cutting devices. Thereby it is advantageous for the simplification of the device to unite the neighbouring initial and end modules of such modules Mx to a structural and movement unit so that only one push and pulling drive 5 is required therefor, as shown in FIGS. 19 and 20. FIGS. 19 and 20 show a plurality of such extension modules Mx in accordance with FIG. 21, which are in each case combined with an initial module Ma and an end module Mz and are in operation at the same time for chamfering and cutting.

As FIG. 20 shows a plurality of end modules Mz can be arranged one after another in the passage direction and notch and cut the strand 2a, whereby a group having an initial module Ma, one or more extension modules Mx and an end module Mz notches and cuts the strand 2a preferably simultaneously, so that a notching process including at least two notching strips 4 or chamfering strips 15 lying opposite one another, or a notching and cutting process including all notching strips 4 or chamfering strips 15 can be effected for the group preferably at the same time.

Within the scope of the invention it is possible not to connect the chamfering strips 15a of the extension modules Mx in each case with one another, but by means in each case of at least one own associated push and pull drive 5 to move preferably simultaneously, as is indicated in FIG. 20 by broken lines.

In the embodiments in accordance with FIGS. 26 to 28 a notching device 21 with two notching rollers 23 is provided, whereby a cutting device with a cutting wire 13 is so integrated into the notching device 21 that the notching and cutting are effected at the same time.

This notching device 21 has on two sides of the clay strand 2 or transport passage 3 lying opposite one another in each case an e.g. fork-like roller holder 22, on which there are mounted two roller plates 23a, 23b of a notching roller 23 rotatably around axis 24 or shaft extending approximately parallel to the middle axis 3a. The roller plates 23a, 23b are arranged at an axial spacing e from one another, which is the same as, or under consideration of a play for movement, is greater than the cross-sectional dimension of the cutting wire 23, which therefore not only has space between the roller plates 23a, 23b of both notching rollers 23, but the roller plates 23a, 23b bound the cutting wire 13 with their sides facing one another, through which the cutting wire 13 is given a guide and is stabilized.

The roller plates 23a, 23b have at their perimeter the desired notching contour or the desired notching angle.

In the region of the axes 24 and of the web 22a of the roller holder 22 the cutting wire 13 can extend through channels arranged therein if it is to extend further to an associated cutting device. However, the cutting wire 13 can also extend radially next to the axes 24 or shafts. Significant is that the cutting wire extends in the middle region of the roller plates 23a, 23b and crosses the perimeter of the roller plates 23a, 23b in the arc region B, in which the roller plates 23a, 23b enter into the clay strand 2 upon notching.

Within the scope of the invention the roller holders 22 can also form holder and guide parts for the cutting wire 13 and therefore in this regard form the cutting device.

The notching device 21 is thus combined with the cutting device so that it is possible to notch and to cut the clay strand at the same time. The cutting direction, indicated with a double arrow, can be vertically directed (FIG. 26) or horizontally directed (FIG. 28). With a vertical cutting direction the roller holders 22 and notching rollers 23 are located in a lateral position with regard to the clay strand 2 or the transport passage 3. With a horizontal cutting direction these parts are above and below the clay strand 2 or transport passage 3.

For notching, the notching device 21 is moved with the cutting wire 13 in each case from one side of the clay strand 2 or transport passage 3 to the other side. There is therefore not required any movements of the notching rollers 23 between a release position and a notching position on the clay strand 2 and away from this, as is the case with the notching and chamfering strips 4, 15.

Within the scope of the invention it is however also possible to move the notching roller 23, or two notching rollers 23 lying opposite to one another with regard to the transport passage, back and forth between a release position and a notching position by means of a drive.

For a notching and cutting process the two notching rollers 23 arranged on sides lying opposite one another are moved from a position in which, with the cutting wire 13, it is located on another side of the clay strand 2 or transport passage 3, to the opposite side, whereby the notching rollers 23 enter to the notching depth t into the clay strand 2 and with the advance of the notching rollers 23 roll-in two oppositely lying notches simultaneously. Also at the same time the clay strand 2 is cut with the cutting wire 13 arranged between the roller plates 23a, 23b in the continuing entry area B.

To get a clean green body edge at least on the side of the clay strand 2 on which the cutting wire 13 exits, it is advantageous to arrange on this side, preferably also on the opposite entry side, a chamfering device 25 having two chamfering strips 26a, 26b extending transversely of the transport passage 3, which have a spacing from one another directed longitudinally of the middle axis 3a, which corresponds under consideration of the cutting gap d to the transverse dimension of the cutting wire 13 with play for movement. There is associated, e.g. in the above-described sense, with the two chamfering strips 26a, 26b in each case at least one, push and pull drive 5, with which the chamfering strips 26a, 26b are movable between their release positions and notching positions as has been described for the chamfering strips 15.

For the forming of an associated chamfer into the clay strand 2 the chamfering strips 26a, 26b are moved against this before the notching rollers 23 are moved with the cutting wire 13 against the clay strand 2 for the execution of each notch. To avoid a collision of the roller plates 23a, 23b with the chamfering strips 26a, 26b, the latter have inward at their ends recesses 26c preferably adapted to the notching form of the roller plates, through which the roller plates 23a, 23b are movable.

To ensure a disruption free introduction of the cutting wire 13 into the slit between the chamfering strips 26a, 26b, the slit has at its side away from the transport passage 3 a funnel-shaped expansion 26e.

With this notching device 21 the notching rollers 23 may be driven with a circumferential speed corresponding to the advancing or cutting speed when cutting, or not. In the first case (driven) the load on the material of the strand 2 is relatively slight because the material does not have to drive the notching rollers 23 with regard to their roll-off movement. In the second case the rotary drive of the notching rollers 23 or roller plates 23a, 23b is effected by a carrying along function of the material.

A drive 27 for one or each of the notching rollers 23 may have e.g. a gear rack 31 which extends parallel to the cutting direction and is connected to the associated notching roller 23 by a drive connection, e.g. a gear train 28. Within the scope of the invention a respectively associated electrical drive motor can also be provided for the notching rollers 23.

With the notching device 21a notching roller 23 need not be present on each of the sides lying opposite one another. This notching device 21 works also when only one notching roller 23 with the cutting wire 13 is present on one side. On the opposite side the notching device could e.g. have instead of a notching roller two further chamfering strips 26a, 26b with associated push and pull drives 5.

With all embodiments the movement of the cutting device or of the cutting wire 13 (FIGS. 1 to 18 and 26 to 28) or of the cutting wires 13 forming a movement unit (FIGS. 19 and 20) can be so controlled that the cutting movement is always effected from one and the same side to the other side. The cutting wire or the cutting wires 13 are thereby returned after every cut, in order always to cut starting from the same side. This makes it necessary that the cut clay strand 2 must, after the cut, be moved mechanically somewhat apart from one another (some mm) by a spreader device, in order to create a gap, in which the cutting wire 13 can be returned without touching the clay strand 2 or the cut green body.

Within the scope of the invention it is however also possible and advantageous for reasons of efficiency to control the cutting device or the cutting wire or cutting wires 13 bidirectionally. This means that the cutting wire or the cutting wires 13 are alternately moved from one side of the clay strand 2 or the transport passage 3 to the other side and then from this other side to the one side again, whereby it or they cut the clay strand 2. With such a control there is no idle travel; rather with both transverse motions of the cutting wire or cutting wires 13 cutting takes place alternately from the one side to the other side.

It is advantageous with all embodiments in per se known manner to move the cutting wire or the cutting wires 13, or the unit combined from notching device 21 and cutting wire 13 in the embodiments in accordance with FIGS. 26 to 28, in dependence upon the transport speed of the clay strand 2 in the strand running direction 10, with the transport speed, so that the notching and cutting can be effected during the transport of the clay strand 2.

Within the scope of the invention it is further possible to move the cutting wire or the cutting wires 13 with a horizontal cutting direction or vertical cutting direction. In both cases the cutting wire or cutting wires 13 are preferably arranged in a position inclined with regard to the cutting direction, as is represented schematically in FIGS. 1 and 2.

In the above-described embodiments the notching surfaces 5c are described as wedge surfaces. Within the scope of the invention the notching webs 4a and the chamfer webs 15b may have notching surfaces 4c or chamfer surfaces rounded convexly. The notching surfaces 4c or chamfer surfaces can also be angled in roof-like manner in cross-section.

1. Device for the separation of a plastic clay strand (2), movable longitudinally of a transport passage (3), into green bodies (2a), having at least one notching device (1) for notching of the clay strand (2) and a cutting device for cutting the clay strand (2) in the notches,
wherein the notching device (1) has notching strips (4) arranged on all sides of the transport passage (3),
characterised in that,
all notching strips (4) are mounted independently of one another and are movable out of a release position into a notching position offset towards the middle axis (3a) of the transport passage (3), and back again.

2. Device according to claim 1,
characterised in that,
two notching strips (4) lying opposite one another, preferably two notching strips (4e, 4g) lying sideways opposite one another, or all notching strips (4d to 4g), can be moved into their notching position at the same time, in particular also can be moved back at the same time.

3. Device according to claim 1 or 2,
characterised in that,
the notching strips (4) are movable in each case by a push and pull device arranged in the middle, or by two push and pull devices (5) arranged to the two sides of their longitudinal middle.

4. Device according to claim 3,
characterised in that,
the push and pull devices (5) are supported on a frame (6) which surrounds the transport passage (3).

5. Device according to claim 4,
characterised in that,
the frame (6) is formed by a plate.

6. Device according to any preceding claim,
characterised in that,
in each case two neighbouring end regions of the notching strips (4) have mitre inclines (8).

7. Device according to claim 6,
characterised in that,
in one mitre surface, or in both mitre surfaces towards one another, of the mitre inclines (8) there is or are arranged at least one recess (9) for receiving clay material of the clay strand (2).

8. Device according to claim 7,
characterised in that,
the at least one recess (9) is open towards the outer peripheral region of the notching strips (7).

9. Device according to claim 8,
characterised in that,
the at least one recess (9) extends up to, or up to the vicinity of, the corner edges (15d) which are formed by the mitre inclines (8) and the notching surfaces (14c) of the notching strips (4) towards the transport passage (3).

10. Device according to any of claims 7 to 9,
characterised in that,
there extends from the recess or recesses (9) at least one channel (11a, 11b) in the associated notching strip (4) and emerges at an exit hole (11c) which is offset outwardly with regard to the recess (9).

11. Device according to any preceding claim,
characterised in that,
the notching strips are in each case formed by two chamfering strips (15), extending neighbouring one another in the circumferential direction of the transport passage (3), which have spacing (d) from one another in the longitudinal direction of the transport passage (3), wherein a cutting device with a cutting wire (13) is provided which is movable between the chamfering strips (15) transversely through the transport passage (3).

12. Device according to claim 10,
characterised in that,
there are provided two or more groups, spaced from one another in the longitudinal direction of the transport passage (3), each with two chamfering strips (15) and a cutting wire (13), which for chamfering and cutting are movable substantially at the same time.

13. Device according to claim 12,
characterised in that,
of two neighbouring groups the chamfering strips (15) following one another in the passage direction (10) are connected to one another and are movable by means of a common push and pull device (5).

14. Device according to any preceding claim,
characterised in that,
of two notching strips (4d, 4e) neighbouring one another in a corner, the one notching strip (4d) is extended at least with its notching web (4a) over at least the notching web (4a) of the other notching strip (4e), and the other notching strip (4e) has a recess (4h) at least in its end wall region overlapped by the one notching strip (4d), which recess is adapted to the cross-sectional form of the notching web (4a) of the one notching strip (4d).

15. Device according to claim 14,
characterised in that,
the one notching strip (4d) extends at least up to the outer edge of the other notching strip (4d) and the recess (4h) in the other notching strip (4e) extends continuously.

16. Device according to claim 14 or 15,
characterised in that,
the notching strips (4d, 4f or 4e, 4g) lying opposite one another vertically and/or horizontally are arranged and constituted mirror symmetrically with regard to the middle axis (3a) of the transport passage (3).

17. Device according to any of claims 14 to 16,
characterised in that,
the overlapping notching strips (4d, 4f) are upper and lower notching strips or lateral notching strips (4e, 4g).

18. Device according to any of claims 14 to 17,
characterised in that,
at least one, preferably both, overlapped notching strips (4e, 4g) are adjustable by means of an adjustment device (4j) with regard to their release position in direction towards the transport passage (3) and back, and are positionable in the respective adjustment position.

19. Device according to claim 15,
characterised in that,
the notching strips (4d bis 4g) are in their corner regions following one another in the peripheral direction each formed and arranged rotated by 90° with regard to the preceding corner region.

20. Device according to claim 19,
characterised in that,
the upper and lower notching strip (4d, 4f) and at least one lateral notching strip (4e) are in each case adjustable in the peripheral direction by means of an adjustment device (4k) and are positionable in the respective adjusted position.

21. Device for the separation of a plastic clay strand (2), movable longitudinally of a transport passage (3), into green bodies (2a), having at least one notching device for notching of the clay strand (2) and a cutting device for cutting the clay strand (2) in the notches,
wherein the notching device (1) has notching strips (4) arranged on all sides of the transport passage (3) and movable between a release position and a notching position,
characterised in that,
the notching strips are in each case formed by two chamfering strips (15), extending neighbouring one another in the circumferential direction of the transport passage (3), which have spacing (d) from one another in the longitudinal direction of the transport passage (3), wherein a cutting device with a cutting wire (13) is provided which is movable between the chamfering strips (15) transversely through the transport passage (3).

22. Device according to claim 21,
characterised in that,
there are provided two or more groups, spaced from one another in the longitudinal direction of the transport passage (3), each with two chamfering strips (15) and a cutting wire (13), which for chamfering and cutting are movable substantially at the same time.

23. Device according to claim 22,
characterised in that,
of two neighbouring groups the chamfering strips (15) following one another in the passage direction (10) are connected to one another and are movable by means of a common push and pull device (5).

24. Device according to any of claims 14 to 23,
characterised in that,
the chamfering strips (15) following one another in the passage direction (10) are connected with one another by means of a strip web (16) and the push and pull device (5) engages on the strip web (16).

25. Device according to any preceding claim,
characterised in that,
in each case two neighbouring end regions of the notching strips (4) or chamfering strips (15) have mitre inclines (8).

26. Device according to claim 25,
characterised in that,
at least one recess (9, 9a) for receiving clay material of the clay strand (2) is or are arranged in one or both mitre surfaces of the mitre inclines (8) towards one another.

27. Device according to claim 26,
characterised in that,
from the recess or the recesses (9) there extends at least one channel (11a, 11b) in the associated notching strip (4) and emerges at and exit hole (11c) which is offset to the outside with regard to the recess (9).

28. Device according to claim 26 or 27,
characterised in that,
the recess surfaces (9c) run out at the corner edges (15d) of the chamfer surfaces (15a) or at a small spacing therefrom.

29. Device for the separation of a plastic clay strand (2), movable longitudinally of a transport passage (3), into green bodies (2a), having at least one notching device with at least one notching roller (23) arranged at least one side the transport passage (3) for notching of the clay strand (2) and a cutting device having a cutting wire (13) extending transverse to the transport passage (3) for cutting the clay strand (2) in the notches,
characterised in that,
the notching roller (23) is formed by two roller plates (23a, 23b) which have an axial spacing from one another, wherein the cutting wire (13) extends between the roller plates (23a, 23b) and intersects the middle region of the roller plates (23a, 23b).

30. Device according to claim 29,
characterised in that,
also on the opposite side of the transport passage (3) there are arranged two roller plates which have an axial spacing from one another, wherein the cutting wire (13) extends also between these roller plates (23a, 23b) and intersects the middle region thereof.

31. Device according to claim 29 or 30,
characterised in that,
at the side of the notching roller (23) neighbouring the transport passage (3) there is provided in each case a chamfering device with a cutting gap (d) for the cutting wire (13).

32. Device according to claim 31,
characterised in that,
the chamfering devices are formed in each case by two chamfering strips (26a, 26b), having the cutting gap (d) between them, which are movable by a push and pull device (5) transverse to the transport passage (3) between a release position and an chamfering position.

33. Device according to claim 32,
characterised in that,
the chamfering strips (26a, 26b) have at their ends inside recesses (26c) for the passage of the roller plates (26a, 26b).
